(19) United States
(12) Patent Application Publication
(10) Pub. No.: US 2017/0023312 A1
(43) Pub. Date: Jan. 26, 2017

(54) Enhanced Heat Transfer In Printed Circuit Heat Exchangers

(71) Applicant: Nicholas F. Urbanski, Katy, TX (US)

(72) Inventor: Nicholas F. Urbanski, Katy, TX (US)

(21) Appl. No.: 15/147,170

(22) Filed: May 5, 2016

Related U.S. Application Data
(60) Provisional application No. 62/196,713, filed on Jul. 24, 2015.

(51) Int. Cl. F28F 3/04; F28F 13/12; F28D 9/00

(52) U.S. Cl. CPC F28F 3/04; F28D 9/0037; F28F 13/12; F28F 2255/00; B33Y 10/00

(57) ABSTRACT

The disclosure includes a heat exchanging apparatus, comprising a heat exchanger plate comprising a plurality of flow passages, and wherein each flow passage comprises at least one surface feature configured to change the flow characteristics of a linear flow along an axis of flow for the flow passage. The disclosure further includes a method of constructing a heat exchanger, comprising using additive manufacturing to form a first plate having a plurality of flow passages, wherein each of the flow passages has one or more integrally formed surface features, wherein the integrally formed surface features are configured to change the flow characteristics of a fluid flowed linearly along an axis of flow for the flow passage.

### CROSS REFERENCE TO RELATED APPLICATIONS

This application claims the priority benefit of U.S. Patent Application 62/196,713 filed Jul. 24, 2015 entitled ENHANCED HEAT TRANSFER IN PRINTED CIRCUIT HEAT EXCHANGERS, the entirety of which is incorporated by reference herein.

### TECHNOLOGICAL FIELD

Exemplary embodiments described herein pertain to three dimensional (3D) printing/additive manufacturing. More specifically, some exemplary embodiments described herein apply 3D printing/additive manufacturing to change the heat transfer and/or flow characteristics of printed circuit heat exchangers.

### BACKGROUND

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of prior art.

Generally, conventional heat exchangers accomplish heat transfer from one fluid to another across a heat exchange surface. In plate type heat exchangers, fluids exchange heat while flowing through heat exchange zones between adjacent (stacked) peripherally sealed thin metal heat exchanger plates. Plate type heat exchangers offer the benefits of counter-current thermal contact, a large easily adjustable surface area-to-volume ratio, and relative compactness. Plate type heat exchangers are the most popular alternative to the more conventional shell-and-tube type heat exchangers for these reasons. Heat exchanger plates may be manufactured by pressing, embossing or other techniques known in the art to create long lengths of corrugated patterns and/or interleaving ridges forming plate paths, flow channels, and/or flow passages, wherein indirect heat exchange may take place between fluids disposed on either side of the ridges. These processes generally aim to produce a uniform, smooth, and defect-free flow passage. However, room for improvement exists in this technology and efficiencies may be increased.

Printed Circuit Heat Exchangers (PCHE) provide the ability to exchange large quantities of energy between numerous streams in a compact unit as compared to conventional shell-and-tube heat exchangers. The heat exchanger plate layers of these PCHE are comprised of sheets of metal into which the desired flow passage arrangement is chemically etched. Each flow passage may be approximately 2.0 millimeters (mm) wide and 1.0 mm deep. Each heat exchanger plate, sheet, or layer of flow passages may have representative dimensions of 600 mm in width and 1,500 mm in length. Multiple heat exchanger plates may be stacked and placed into a vacuum furnace, wherein the collection of these individual layers becomes one solid piece via a process called diffusion bonding. A representative depth of a final assembly or core may be 600 mm. Multiple assemblies or cores may be joined together to form a final heat exchanger unit. Chemical etching aims to produce a uniform, smooth, and defect-free flow passage. However, room for improvement exists in this technology and efficiencies may be increased.

Additive manufacturing techniques are increasingly used in manufacturing. Typically, additive manufacturing techniques start from a digital representation of the object to be formed generated using a computer system and computer aided design and manufacturing (CAD/CAM) software. The digital representation may be digitally separated into a series of cross-sectional layers that may be stacked or aggregated to form the object as a whole. The additive manufacturing apparatus, e.g., a 3D printer, uses this data for building the object on a layer-by-layer basis. Additional background information is known in the art and may be found in U.S. Patent Applications 2014/0205454, 2014/0163717, 2014/0154088, 2014/0124483, 2013/0310961, 2013/0320598, 2013/0316183, and 2013/0149182, and European Patent Application 2675583, each of which is hereby incorporated by reference in their entirety.

### SUMMARY

This disclosure includes a heat exchanging apparatus, comprising a heat exchanger plate comprising a plurality of flow passages, and wherein each flow passage comprises at least one surface feature configured to change the flow characteristics of a linear flow along an axis of flow for the flow passage.

The disclosure further includes a method of constructing a heat exchanger, comprising using additive manufacturing to form a first plate having a plurality of flow passages, wherein each of the flow passages has one or more integrally formed surface features, wherein the integrally formed surface features are configured to change the flow characteristics of a fluid flowed linearly along an axis of flow for the flow passage.

The disclosure additionally includes a method of using a heat exchanging apparatus, comprising flowing a first fluid through a first flow passage, wherein flowing comprises passing the fluid along the first flow passage, disturbing a flow of the fluid using a plurality of surface features disposed at regular intervals along an axis of flow for the flow passage, wherein the plurality of surface features allow the flow of fluid to continue flowing along the axis of flow for the flow passage, and flowing a second fluid through a second flow passage, wherein heat is exchanged between the first fluid and the second fluid.

### BRIEF DESCRIPTION OF THE DRAWINGS

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims. It should also be understood that the drawings are not necessarily to scale, emphasis instead being placed upon clearly illustrating principles of exemplary embodiments of the present invention. Moreover, certain dimensions may be exaggerated to help visually convey such principles.

FIG. 1 is an exemplary exploded view of a conventional welded plate frame heat exchanger.

FIG. 2 is a perspective view of a conventional PCHE plate.

FIG. 3 is a perspective view of another conventional PCHE plate.

FIG. 4 is a cross-section view of a first embodiment heat exchanger plate having flow passage sections each having a different flow passage profile.

FIG. 5 is a cross section view of a second embodiment heat exchanger ate a flow passages each having a different flow passage profile.

FIG. 6 is a perspective view a third embodiment of a heat exchanger plate.

FIG. 7 is a perspective view a fourth embodiment of a heat exchanger plate.

FIG. 8A is a top view of a first embodiment flow passage having surface features extending vertically into the respective flow passage.

FIG. 8B is a top view of a second embodiment flow passage having surface features extending vertically into the respective flow passage.

### DETAILED DESCRIPTION

Exemplary embodiments are described herein. However, to the extent that the following description is specific to a particular, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

The present technological advancement can capture technology opportunities through the use of additive manufacturing as a technique to change various operating characteristics for PCHE-type heat exchangers. Current techniques aim to produce a uniform, smooth, and defect-free flow passage. However, the present disclosure includes techniques to produce irregular flow passages that can change flow characteristics for flow within and/or along a channel to improve overall heat transfer along the channel. Moreover, the present disclosure accomplishes this technique as enabled by new and previously unavailable manufacturing capabilities that permit the present techniques to precisely control what variations are placed within and/or along a channel and with what frequency within a precise tolerance, e.g., to within ±2 mm, ±1.5 mm, ±1 mm, ±0.75 mm, ±0.5 mm, ±0.25 mm, ±0.1 mm, ±0.05 mm, etc. Thus, the present advancement provides an alternative solution to the problem described above in a unique way by teaching away from earlier developments.

As used herein, the phrase “additive manufacturing” means a process of creating a three dimensional (3D) item of manufacture/equipment, where successive layers of material are laid down to form a three-dimensional structure. Exemplary 3D printing techniques include, but are not limited to, Scanning Laser Epitaxy (SLE), Selective Laser Sintering/Hot Isostatic Pressing (SLS/HIP), Fused Deposition Modeling, foil-based techniques, and direct metal laser sintering (DMLS).

As used herein, the phrase “aggregate flow” means a flowing fluid understood in its bulk entirety within the context of a flow passage and not viewed or analyzed in discrete, disaggregated portions or segments. For example, an aggregate flow may be described as generally having a single, horizontal direction of flow along an axis of flow for a flow passage while comprising discrete, lesser portions therein of eddy, turbulent, or other limited cross- or counter-directional flow with respect to the aggregate flow. A flow passage will have a single direction of aggregate flow along an axis of flow for that flow passage or portion thereof

As used herein, the phrase “indirect heat exchange” means the bringing of two fluids into heat exchange relation without any physical contact or intermixing of the fluids with each other.

As used herein, the phrase “integrally formed” means constructed, fabricated, manufactured, printed, sintered, and/or machined such that the component is comprised of the same unitary material as the substrate. As used herein, the phrase “integrally formed” does not mean brazed, welded, embedded, bonded, or otherwise affixed or coupled as one component onto a second component, e.g., as with an inline valve, flow restrictor, baffle, etc. as conventionally installed along a flowpath. Integrally forming a structure on a substrate explicitly includes fabricating a component on a substrate by one or more additive manufacturing techniques. Integrally forming a structure on a substrate includes forming the component as a negative space, channel, depression, cavity, or other such space along the substrate. Integrally forming a structure on a substrate may occur at the same time as fabrication of the substrate.

As used herein, the phrase “flow passage profile” means the cross-sectional shape of the relevant flow passage. For example, flow passage profiles may be generally circular, triangular, oblong, rectangular, polygonal, etc., or any combination thereof.

As used herein, the phrase “flow passage wall” means any outer boundary of a given flow passage, including any applicable sides, floors, and/or ceilings for a given flow passage.

As used herein, the term “fluid” means gases, liquids, and combinations of gases and liquids, as well as to combinations of gases and solids, and combinations of liquids and solids.

As used herein, the term “substantial” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

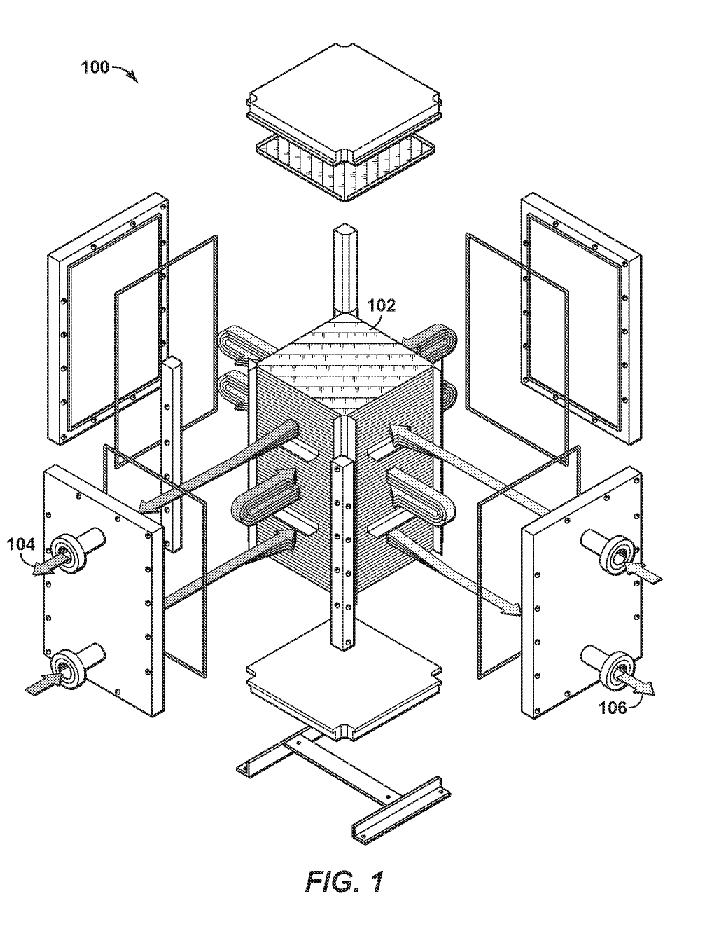

FIG. 1 is an exemplary exploded view of a conventional welded plate frame heat exchanger 100. Heat exchanger 100 (e.g., a plate frame exchanger (PFE)) includes a core 102 and various frame and housing components. The core 102 includes a plurality of metal plates that are configured to transfer heat between fluids 104 and 106. The metal plates are compressed together in a rigid frame to form an arrangement of parallel flow passages with alternating hot fluids 104 and cold fluids 106. The metal plates may be corrugated plates, e.g., having intermating and/or chevron corrugations, and the flow passages themselves may be strictly linear or may have a wavy, a zigzag, or other shape pressed into the plate.

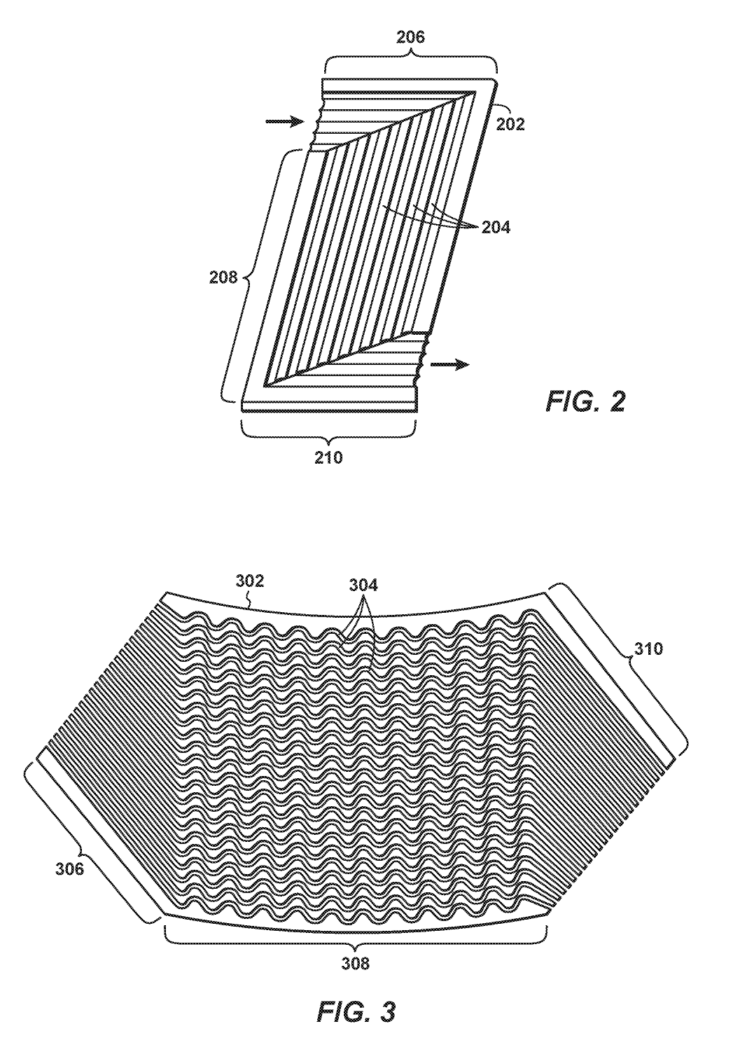

FIG. 2 is a perspective view of a conventional PCHE plate 202, e.g., the heat exchanger plate of core 102 of FIG. 1, having a plurality of flow passages 204 extending from an inlet section 206, along an intermediate section 208, and to an outlet section 210. The flow passages 204 are arranged in parallel and are substantially uniform along their respective axis of flow.

FIG. 3 is a perspective view of another conventional PCHE plate 302, e.g., the heat exchanger plate of core 102 of FIG. 1, having a plurality of flow passages 304 extending from an inlet section 306, along a wavy intermediate section 308, and to an outlet section 310. The flow passages 304 are arranged in parallel and are substantially uniform along their respective axis of flow. Each flow passage of the wavy intermediate section 308 comprises two curved edges (sides) directing an aggregate flow through various axis of flow depending on the position of aggregate flow in the wavy intermediate section 308.

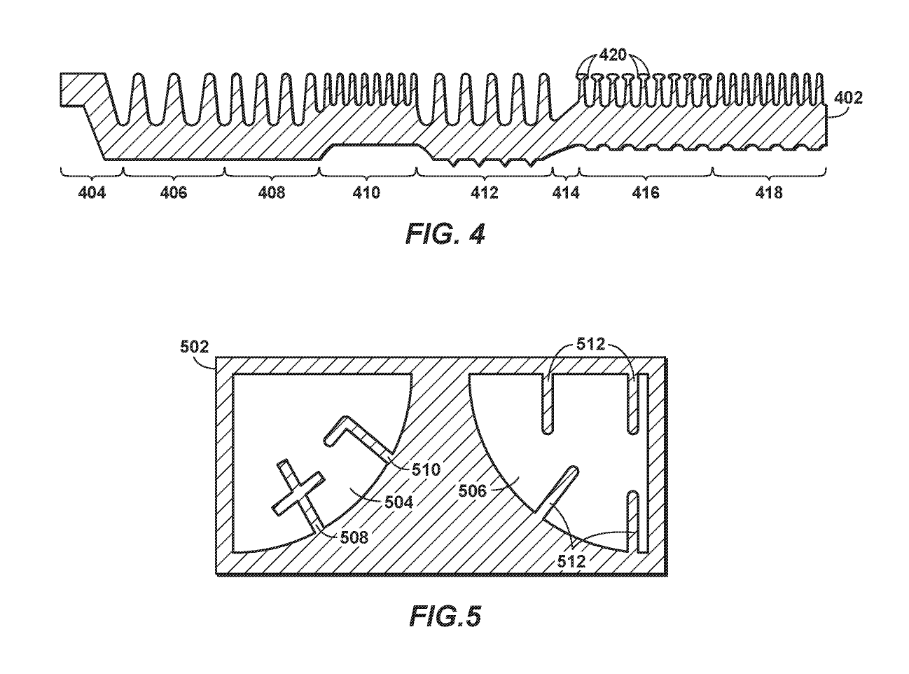

FIG. 4 is a cross-section view of a heat exchanger plate 402, e.g., the heat exchanger plate of core 102 of FIG. 1, having flow passage sections 404-418 each haying a different flow passage profile. The flow passage profiles of the flow passage sections 404-418 depict a variety of flow passage depths, widths, sidewall slopes, and shapes. Various embodiments of heat exchanger plates as described herein may comprise one or more of these flow passage sections 404-418, and may do so in a manner wherein different flow passage sections having different flow passage profiles are situated adjacently (as illustrated), in series, or in any combination thereof. Additional designs for flow passage sections disclosed herein having different flow passage profiles include flow passage profiles with generally circular shapes, triangular shapes, oblong shapes, rectangular shapes, polygonal shapes, etc., or any combination thereof Other embodiments may change in measurement from one flow passage to another or along the length of a single flow passage, e.g., by varying the surface feature extension height, surface feature recess depth, surface feature diameter, and/or surface feature curvature. For example, each wall of the flow passage section 416 comprises an integrally formed surface feature 420 that extends partially into the associated flow passage. The surface features 420 as depicted extend into between 1% and 49% of the illustrated flow passage width, permitting some portion of fluid to flow between opposing surface features 420 for each flow passage of the flow passage section 416. Alternate embodiments may further restrict flow and permit no fluid to pass between opposing surface features 420. Still other embodiments may permit a relatively greater amount of fluid to pass between opposing surface features 420, e.g., by extending between 1%-10%, 1%-20%, 1%-30%, 1%-40%, 1%-45%, 10%-20%, 10%-30%, 10%-40%, 10%-45%, 20%-30%, 20%-40%, 20%-45%, 30%-40%, 30%-45%, or 40%-45% of the flow passage width. In some embodiments, the flow passage width is approximately 2.0 millimeters (mm) wide and approximately 1.0 mm deep. While the surface features 420 are depicted as extending from the top of the walls of the flow passage section 416, any location along the boundary of the flow passage may be employed as a surface feature mounting location within the scope of this disclosure. As described above, some flow passage sections may be placed in series, and in such embodiments an average flow passage width may be used for measuring the extension of the surface features 420. Additionally or alternatively, those of skill in the art will appreciate that a single surface feature extending from a single wall of a flow passage may be used to accomplish the same characteristics, e.g., by extending between 1%-50%, 1%-60%, 1%-70%, 1%-80%, 1%-90%, 10%-50%, 10%-60%, 10%-70%, 10%-80%, 10%-90%, 20%-50%, 20%-60%, 20%-70%, 20%-80%, 20%-90%, 30%-50%, 30%-60%, 30%-70%, 30%-80%, 30%-90%, 40%-50%, 40%-60%, 40%-70%, 40%-80%, 40%-90%, 50%-60%, 50%-70%, 50%-80%, 50%-90%, 60%-70%, 60%-80%, 60%-90%, 70%-80%, 70%-90%, or 80%-90% of a flow passage width, within the scope of the present disclosure. In some embodiments, the flow passage width is approximately 2.0 millimeters (mm) wide and approximately 1.0 mm deep.

FIG. 5 is a cross section view of a heat exchanger plate 502 having flow passages 504 and 506 each having a different flow passage profile. The components of FIG. 5 may be substantially the same as the corresponding components of FIG. 4 except as otherwise noted. Integrally formed surface features 508-512 extend from a flow passage wall into the flow passages 504 and 506. The surface features 508-512 are mounted along an axis different from the axis of flow for the associated flow passages 504 and 506, namely, perpendicular to the axis of flow. Some embodiments may space the surface features 508-512 at regular intervals along the mounting axis, along the axis of flow, or both. The surface features 508-512 may be configured to create an eddy flow, a turbulent flow, or otherwise obstruct flow. The surface features 508-512 may be configured as needle- or pin-type extensions, fin-type extensions, bumps, ridges, scallops, divots, or another protrusion or recess for changing flow characteristics. The surface features 508-512 may be configured to accelerate flow along the axis of flow for the flow passage, e.g., as a nozzle, or may be configured to create a cyclonic flow along the axis of flow, e.g., as fins, rifling, etc. The depicted surface features 508 and 510 are of differing shape and size, while the depicted surface features 512 are of uniform shape and size. While depicted as adjacent flow passages, those of skill in the art will appreciate that alternate embodiments may place flow passages 504 and 506 in non-adjacent locations, e.g., on separate heat exchanger plates of core 102 of FIG. 1. Those of skill in the art will appreciate that alternate embodiments may create surface features by recessing the surface features 508-512 into the walls of the respective flow passages 504 and 506.

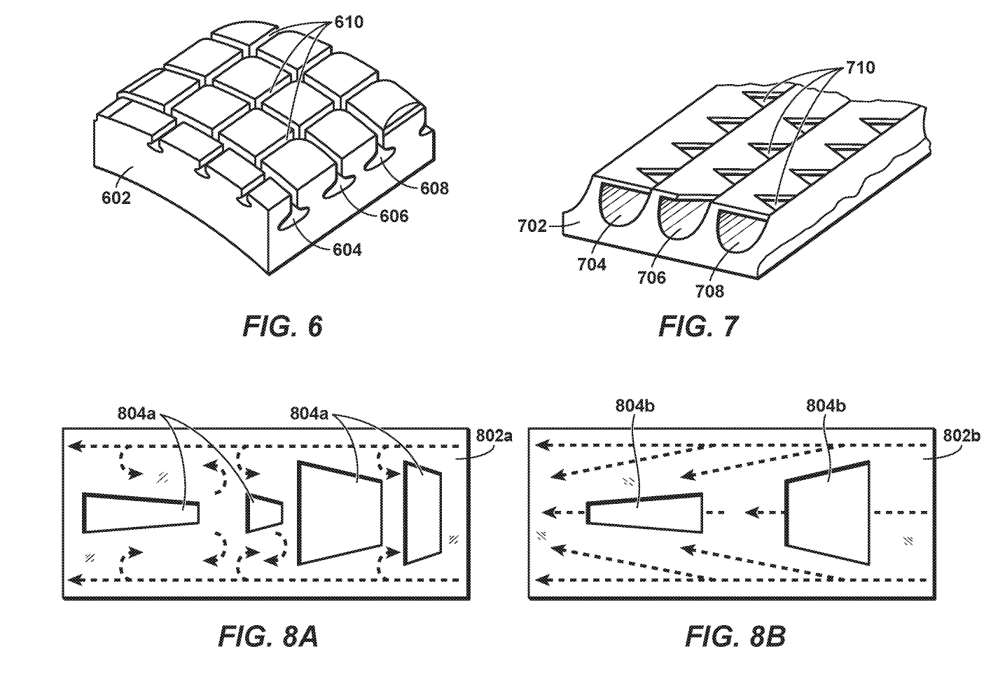

FIG. 6 is a perspective view a heat exchanger plate 602 having flow passages 604-608 as enabled by the techniques disclosed herein. The components of FIG. 6 may be substantially the same as the corresponding components of FIG. 5 except as otherwise noted. The walls of the flow passages 604-608 comprise flow paths 610. While the depicted flow paths 610 permit fluid communication between the adjacent flow passages 604-608, other embodiments of flow paths 610 may permit fluid communication between non-adjacent flow passages, e.g., as tunnels through flow passage walls or across the flow channel(s) of the flow passages. In some embodiments, such flow paths may extend from plate-to-plate rather than from flow passage-to-flow passage along a single plate.

FIG. 7 is a perspective view of a heat exchanger plate 702 having flow passages 704-708 as enabled by the techniques disclosed herein. The components of FIG. 7 may be substantially the same as the corresponding components of FIG. 6 except as otherwise noted. The top walls of the flow passages 704-708 comprise pores 710. The pores 710 permit fluid communication from plate-to-plate rather than from flow-passage-to-flow passage as enabled by the flow paths 610 of FIG. 6. The pores 710 are depicted as triangular but alternate embodiments may optionally select from any suitable configuration to obtain a desired flow characteristic.

FIGS. 8A and 8B are top views of flow passages 802a and 802b having surface features 804a and 804b extending vertically into the respective flow passages. The components of FIGS. 8A and 8B may be substantially the same as the corresponding components of FIG. 7 except as otherwise noted. Flow through the flow passages 802a and 802b is depicted with dashed lines. As depicted, flow across the surface features 804a may result in eddy flow. Additionally, the surface features 804b may be configured for flow to pass through, e.g., as nozzles, flow directors, slats, or other surface features configured to admit the passage of flow therethrough, as depicted by the dashed lines extending through the surface features 804b. Disturbing the flow through the flow passages 802a and 802b may increase the relative thermodynamic mixing of flow through the flow passages 802a and 802b, thereby increasing the efficiency of the associated heat exchanger, e.g., the plate frame heat exchanger 100 of FIG. 1. Alternately or additionally, the surface features 804a and/or 804b may be used to obtain a desired pressure change across the length of the flow passages 802a and son.

The present techniques may be susceptible to various modifications and alternative forms, and the examples discussed above have been shown only by way of example. However, the present techniques are not intended to be limited to the particular examples disclosed herein. Indeed, the present techniques include all alternatives, modifications, and equivalents falling within the spirit and scope of the appended claims.

What is claimed is:

1. A heat exchanging apparatus, comprising:
a heat exchanger plate comprising a plurality of flow passages, and wherein each flow passage comprises at least one integrally formed surface feature configured to change the flow characteristics of a linear flow along an axis of flow for the flow passage.

2. The apparatus of claim 1, wherein the surface feature is configured to:
extend to between 1% and 90% of an average flow passage width of an associated flow passage,
recess to between 1% and 90% of an associated flow passage wall, or
permit fluid communication between a first flow passage and a second flow passage.

3. The apparatus of claim 1, wherein each flow passage comprises a plurality of surface features, wherein the plurality of surface features allow the linear flow as an aggregate flow to continue flowing along the axis of flow for the flow passage, and wherein each of the plurality of surface features is spaced at regular intervals along the axis of flow for the flow passage.

4. The apparatus of claim 1, wherein each flow passage comprises a plurality of surface features, and wherein at least a portion of the plurality of surface features are of uniform shape, uniform size, or both.

5. The apparatus of claim 1, wherein each flow passage comprises a plurality of surface features mounted along an axis different from the axis of flow for the flow passage.

6. The apparatus of claim 1, wherein the surface feature is configured to create a cyclonic flow along the axis of flow for the flow passage, or wherein the surface feature is configured to accelerate flow along an the axis of flow for the flow passage.

7. The apparatus of claim 1, wherein the surface feature is configured to create an eddy flow along the axis of flow for the flow passage, or wherein the surface feature is configured to obstruct flow along an the axis of flow for the flow passage.

8. The apparatus of claim 1, wherein the surface feature is configured to extend to between 1% and 90% of an average flow passage width of the associated flow passage, and wherein the surface feature defines a first flow passage profile for the associated flow passage such that the first flow passage profile for the associated flow passage is different than a second flow passage profile for a second flow passage disposed on the heat exchanging apparatus.

9. The apparatus of claim 1, wherein the surface feature is configured to permit fluid communication between a first flow passage and a second flow passage, and wherein the first flow passage and the second flow passage are non-adjacent.

10. The apparatus of claim 9, wherein the first flow passage and the second flow passage are disposed on non-adjacent plates of the heat exchanging apparatus.

11. The apparatus of claim 1, wherein the surface feature is integrally formed on the heat exchanger plate.

12. The apparatus of claim 1, further comprising a plurality of heat exchanger plates configured the same as the first heat exchanger plate.

13. The apparatus of claim 1, further comprising a second heat exchanger plate comprising a second plurality of flow passages, and wherein each flow passage of the second plurality of flow passages comprises at least one surface feature that is different than the surface features of the first plurality of flow passages of the first heat exchanger plate.

14. The apparatus of claim 2, wherein a measurement of the surface feature changes along the axis of flow for the flow passage, and wherein the measurement is selected from a group consisting of extension height, recess depth, surface feature diameter, curvature.

15. The apparatus of claim 1, wherein a measurement of the surface feature changes along an axis different from the axis of flow for the flow passage.

16. The apparatus of claim 1, wherein each flow passage has an average flow passage width between 0.1 millimeters (mm) and 5.0 mm.

17. A method of constructing a heat exchanger, comprising:
using additive manufacturing to form a first plate having a set of flow passages, wherein each flow passage in the set has one or more integrally formed surface features, and wherein each of the integrally formed surface features are configured to change the flow characteristics of a fluid flowed linearly along an axis of flow for the flow passage.

18. The method of claim 17,
wherein each flow passage in the set has a plurality of integrally formed surface features configured to extend into an associated flow passage and increase turbulence of a fluid flowing along an axis of flow for the associated flow passage, change the pressure of the fluid flowing along the axis of flow for the associated flow passage, change the velocity of the fluid flowing along the axis of flow for the associated flow passage, or a combination thereof, and
wherein at least a portion of the plurality of integrally formed surface features are spaced at regular intervals along the axis of flow for the associated flow passage.

19. The method of claim 17,
wherein at least a first portion of the flow passages have a plurality of integrally formed surface features of uniform shape, uniform size, or both, configured to recess into an associated flow passage wall,
wherein at least a second portion of the surface features are spaced at regular intervals along the axis of flow for the flow passage, and
wherein at least a third portion of the flow passage have an average flow passage width between 0.1 millimeters (mm) and 5.0 mm.

20. The method of claim 17,
wherein at least a portion of the surface features are configured to permit fluid communication between a first flow passage and a second flow passage, and
wherein the first flow passage and the second flow passage are non-adjacent flow passages disposed on non-adjacent plates of the heat exchanging apparatus.

21. A method of using a heat exchanging apparatus, comprising:
flowing a first fluid through a first flow passage having an average flow passage width between 0.1 millimeters (mm) and 5.0 mm, wherein flowing comprises:
passing the first fluid along the first flow passage in a flow;
disturbing the flow using a plurality of integrally formed surface features disposed at regular intervals along an axis of flow for the first flow passage, wherein the plurality of surface features allow the flow to continue flowing along the axis of flow for the first flow passage, and wherein each of the; and
flowing a second fluid through a second flow passage, wherein heat is exchanged between the first fluid and the second fluid.

22. The method of claim 21, further comprising:
flowing a third fluid through a third flow passage, wherein the third flow passage shares a first heat transfer surface with the first flow passage and a second heat transfer surface with the second flow passage.
